(19) United States
(12) Patent Application Publication
(10) Pub. No.: US 2013/0186246 A1
(43) Pub. Date: Jul. 25, 2013

(54) SHEARING APPARATUS

(71) Applicant: Patrick L. Franze, Atwater, OH (US)

(72) Inventor: Patrick L. Franze, Atwater, OH (US)

(21) Appl. No.: 13/749,416

(22) Filed: Jan. 24, 2013

Related U.S. Application Data
(60) Provisional application No. 61/590,290, filed on Jan. 24, 2012.

(51) Int. Cl. B26D 1/06; B26D 7/02

(52) U.S. Cl. CPC B26D 1/06; B26D 7/02
USPC 83/452

(57) ABSTRACT

A shearing apparatus has a movable shearing blade that is moved between retracted and extended positions with a piston cylinder assembly that supplies shearing force to the blade such that the movable shearing blade may be driven through a variety of items such as metal pipes and solid items such as channels or struts. The movable shearing blade can cooperate with a fixed shearing blade disposed on the opposite side of the item being sheared as the movable shearing blade. The movable shearing blade also can cooperate with a support block without the fixed shearing blade. First and second clamp assemblies are provided on different sides of the movable shearing blade.

### CROSS REFERENCE TO RELATED APPLICATIONS

This application claims the benefit of U.S. Provisional Patent application Ser. No. 61/590,290 filed Jan. 24, 2012; the disclosure of which is incorporated herein by reference.

### BACKGROUND OF THE DISCLOSURE

The disclosure is related to apparatus used for shearing different items and, more particularly, to a portable shearing apparatus having individually-movable holders and a driven blade and that may be used to shear different items such as pipes, channels, rods, and struts.

### SUMMARY OF THE DISCLOSURE

The disclosure provides a shearing apparatus having a movable shearing blade that interacts with a fixed shearing blade to shears items disposed in the path of the movable shearing blade.

The disclosure provides a shearing apparatus having a movable shearing blade that is moved between retracted and extended positions with a piston cylinder assembly, which may be hydraulic, that supplies considerable shearing force to the blade such that the movable shearing blade may be driven through a variety of items such as metal pipes and solid items such as channels or struts. The movable shearing blade can cooperate with a fixed shearing blade disposed on the opposite side of the item being sheared as the movable shearing blade. The movable shearing blade also can cooperate with a support block without the fixed shearing blade.

The disclosure also provides a shearing apparatus that includes individually movable clamps that selectively hold the item being sheared. The clamp assemblies also can be used to maintain tension in the item being sheared during the shearing process. Each clamp is controlled with its own piston cylinder assembly.

In one exemplary configuration of the disclosure, each clamp includes a clamp head that nests within a recess defined by the seat of the clamp assembly when the clamp assembly is extended. Each clamp

### BRIEF DESCRIPTION OF THE DRAWINGS

FIG. 1 is a front view of an exemplary configuration of the shearing apparatus with the movable shearing blade in its retracted position and the clamps in their open positions.

FIG. 2 is an exploded front view of the shearing apparatus of FIG. 1 with the blade cover removed to show the movable shearing blade.

FIG. 3 is a front view of the shearing apparatus with the movable blade in the extended position and disposed through an item.

FIG. 4 is a view similar to FIG. 3 showing the upper clamp engaged with the item being sheared.

FIG. 5 is a view similar to FIG. 3 showing the lower clamp engaged with the item being sheared.

Similar numbers refer to similar parts throughout the disclosure.

### DETAILED DESCRIPTION OF THE DISCLOSURE

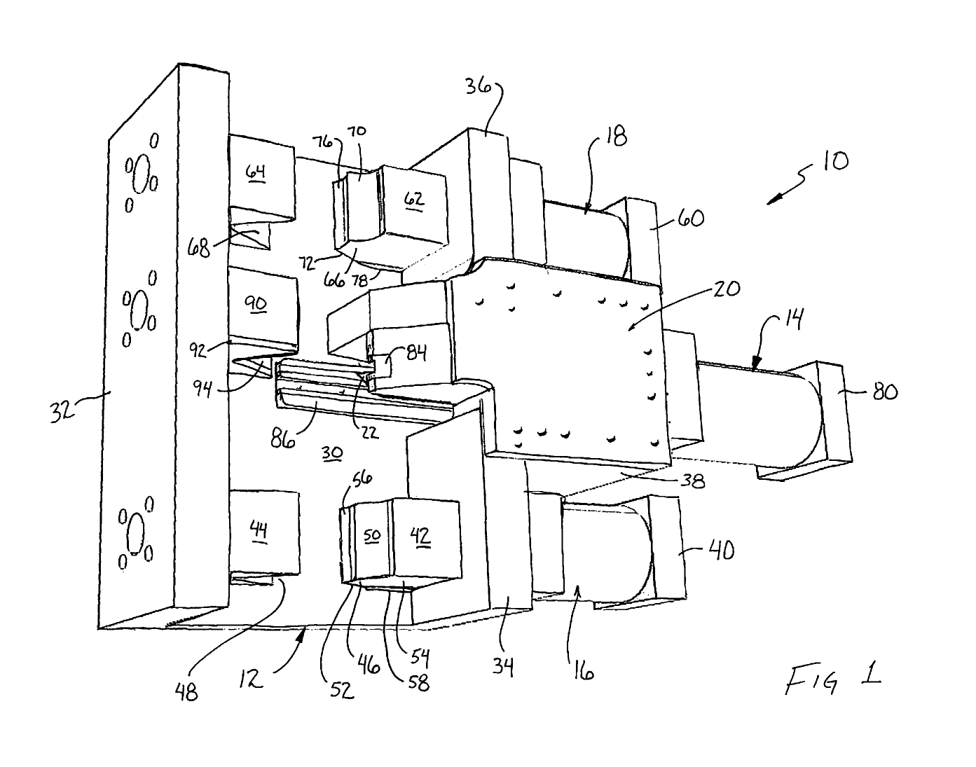

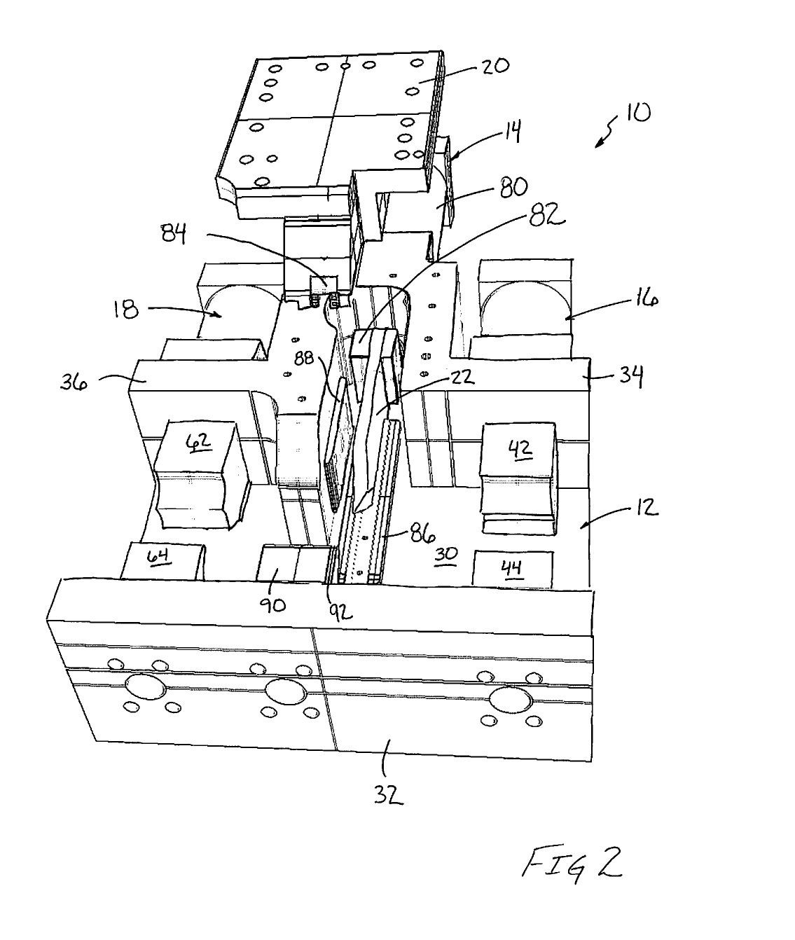

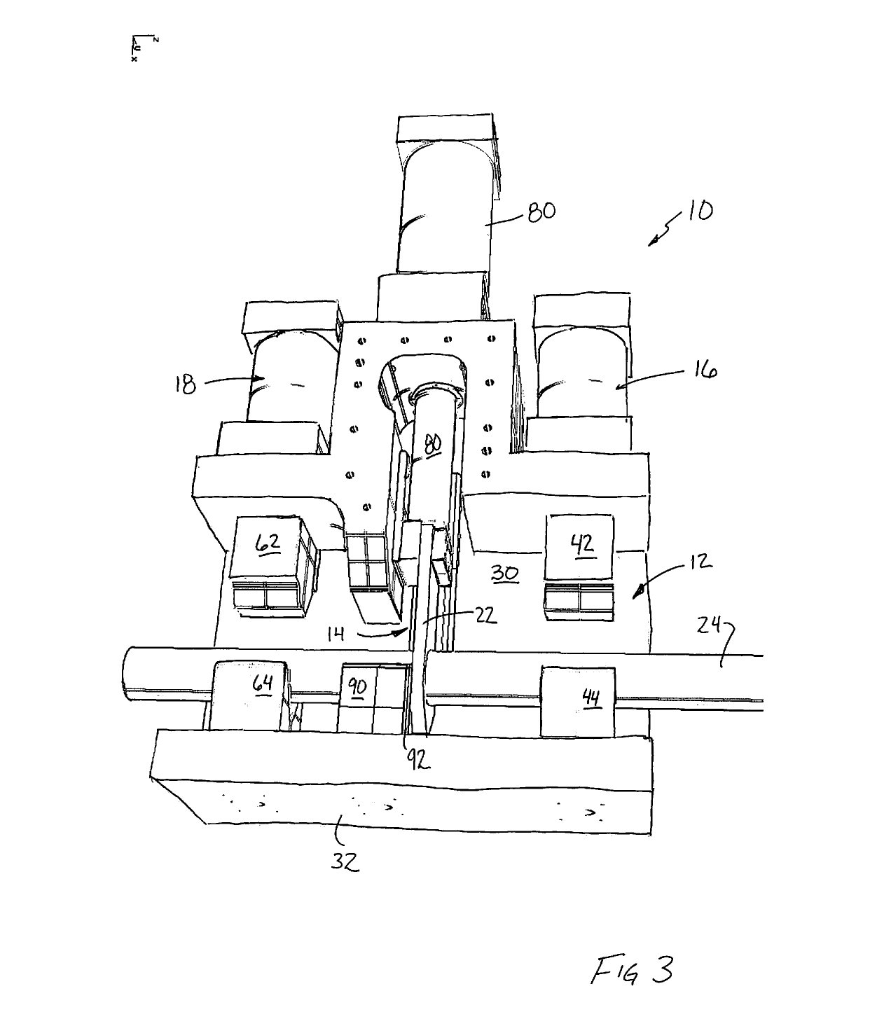

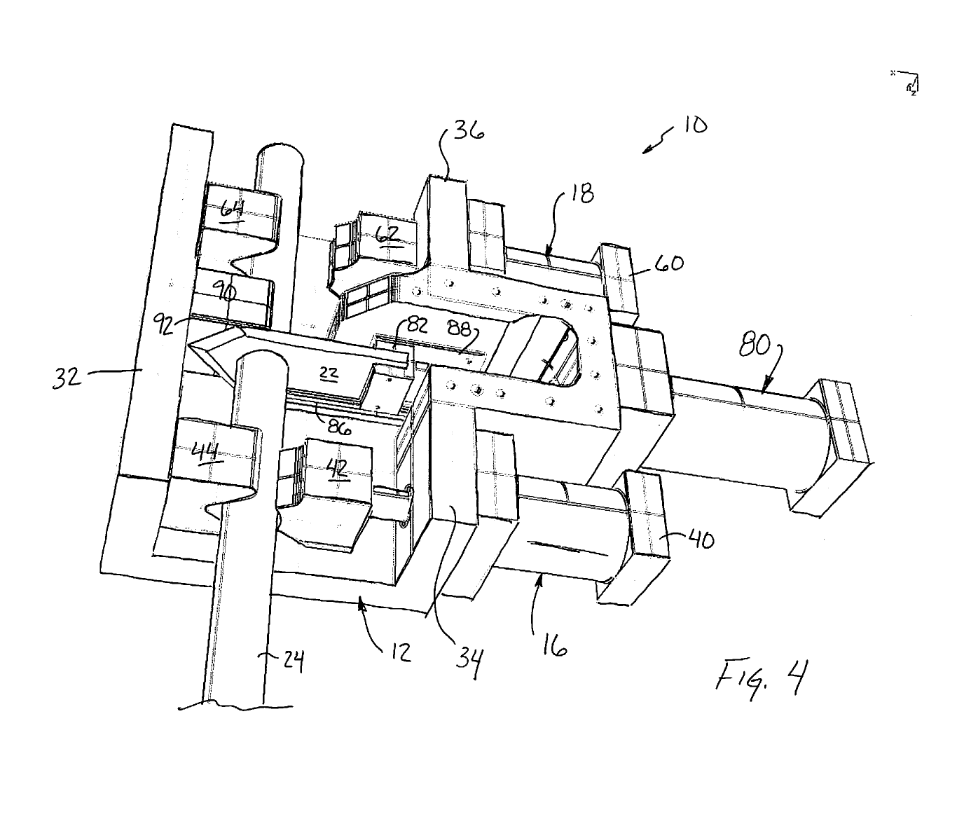

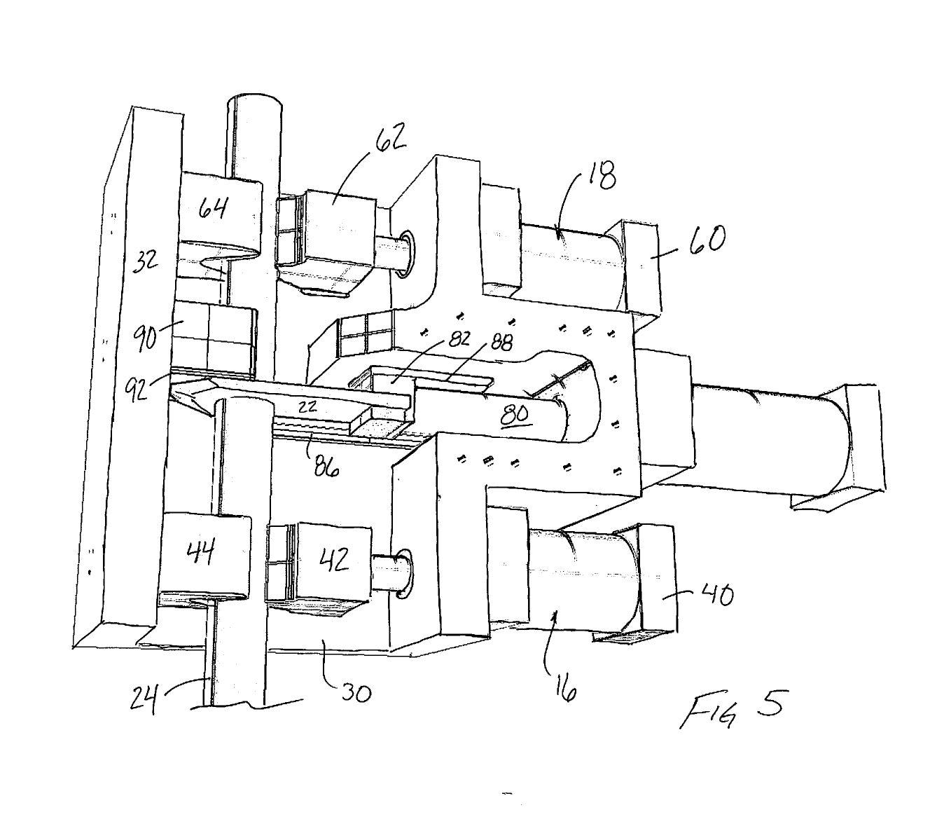

An exemplary shearing apparatus is indicated generally by the reference numeral 10 in the accompanying drawings. Apparatus 10 generally includes a base frame 12, a movable blade assembly 14, a first clamp assembly 16, a second clamp assembly 18, and a blade cover 20. Apparatus 10 is capable of an shearing an item 24 placed in the path of a movable blade 22 of movable blade assembly 14 when moveable blade 22 is moved from its retracted position (FIGS. 1 and 2) to its extended position (FIGS. 3, 4, and 5). The direction defined by the movement of blade 22 is referred to herein as the blade direction or blade axis.

Base frame 12 generally includes a back plate 30, a common support block 32, a first clamp support block 34, a second clamp support block 36, and a blade housing 38. Base frame 12 may be formed as an integral unit or as separate pieces that are individually formed and then connected with mechanical connectors (such as screws, rivets, or bolts) or welds.

First clamp assembly 16 generally includes a piston cylinder 40, a clamp head 42, and a clamp seat 44. Piston cylinder 40 may be a hydraulic piston cylinder that is controlled separately from second clamp assembly 18 and separately from movable blade assembly 14. Piston cylinder 40 is removably connected to first clamp support block 34. Clamp head 42 has a leading end 46 that will nest within a recess 48 defined by clamp seat 44 when head 42 is moved far enough toward seat 44 to bring head 42 into engagement with seat 44. Head 42 includes a tapered leading end 46 that is defined by tapered upper 50 and lower 52 walls extending between parallel sidewalls 54. The leading ends of upper 50 and lower 52 walls converge towards and are connected by an end wall 56 that is curved inwardly to define an elongated cup that extends between sidewalls 54 in a direction substantially perpendicular to the blade direction. Clamp head 42 is removably connected to the piston of piston cylinder 40 and clamp seat 44 is removably connected to common support block 32 so that they may be changed when apparatus is used to shear items 24 with different cross sections. The configuration depicted in the drawings is used with items 24 having round or oval cross sections. Clamp head 42 may carry a wear plate 58 that slides against the front surface of back plate 30.

Second clamp assembly 18 generally includes a piston cylinder 60, a clamp head 62, and a clamp seat 64. Piston cylinder 60 may be a hydraulic piston cylinder that is controlled separately from first clamp assembly 16 and separately from movable blade assembly 14. Piston cylinder 60 is removably connected to second clamp support block 36. Clamp head 62 has a leading end 66 that will nest within a recess 68 defined by clamp seat 64 when head 62 is moved far enough toward seat 64 to bring head 62 into engagement with seat 64. Head 62 includes a tapered leading end 66 that is defined by tapered upper 70 and lower 72 walls extending between parallel sidewalls 74. The leading ends of upper 70 and lower 72 walls are connected by an end wall 76 that is curved inwardly to define an elongated cup that extends between sidewalls 74 in a direction substantially perpendicular to the blade direction. Head 72 is removably connected to the piston of piston cylinder 60 and clamp seat 64 is removably connected to common support block 32 so that they may be changed when apparatus is used to shear items 24 with different cross sections. The configuration depicted in the drawings is used with items 24 having round or oval cross sections. Clamp head 42 may carry a wear plate 78 that slides against the front surface of back plate 30.

Movable blade assembly 14 generally includes movable shearing blade 22 that is connected to the piston of a blade piston cylinder 80 with a blade mount 82 that sandwiches the non-shearing end of blade 22. Blade 22 is seated between upper 84 and lower 86 blade guides. Upper blade guide 84 is carried by cover 20 and lower blade guide 86 is carried by the front surface of back plate 30. Cover 20 includes a boss that projects forward from the top of cover to support most of the length of blade 22 when blade 22 is extended. A wear plate 88 is carried on one inner side of blade housing 38 such that blade mount 82 slides along wear plate 88 when blade 22 is moved back and forth.

A shear block 90 is aligned with blade 22 such that the shearing end of blade 22 slides along the side of shear block 90 when blade 22 is in the extended position. Shear block 90 includes a shear blade 92 that interacts with blade 22 to shear item 24. Both block 90 and blade 92 define a recess 94 that substantially matches recesses 48 and 68 to receive item 24. Block 90 and blade 92 are removably connected to common support block 32.

The shearing end of blade 22 may be triangular or rounded and is tapered toward block 90. When blade 22 is moved to the extended position, blade 22 will slide along blade 92 to shear item 24. Different blades 22 may be installed within apparatus 10 to shear different items 23. The different blades 22 may use the same guides 84 and 86 or guides 84 and 86 may be changed to match blade 22.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A shearing apparatus, comprising:
a base frame;
a blade assembly carried by the base frame; the blade assembly including a movable shearing blade that is movable between retracted and extended positions with a piston cylinder assembly that supplies shearing force to the blade such that the movable shearing blade may be driven through an item to be sheared; and
first and second clamp assemblies disposed on different sides of the movable shearing blade; each of the first and second clamp assemblies movable between extended and retracted positions; the extended position adapted to engage the item to be sheared.

2. The apparatus of claim 1, further comprising a fixed shearing blade carried by the base frame; the movable shearing blade disposed adjacent the fixed shearing blade when the movable shearing blade is in the extended position.

3. The apparatus of claim 2, wherein the fixed shearing blade is disposed adjacent a fixed shear block.
